(19) United States
(12) Patent Application Publication
(10) Pub. No.: US 2026/0087596 A1
(43) Pub. Date: Mar. 26, 2026

(54) SELECTIVE ADAPTATION IN GENERATIVE MACHINE LEARNING MODELS FOR ENHANCING DOMAIN ALIGNMENT

(71) Applicant: QUALCOMM Incorporated, San Diego, CA (US)

(72) Inventors: Minho PARK, Goyang-si (KR); Jungsoo LEE, Paju (KR); Sunghyun PARK, Seoul (KR); Hyojin PARK, San Diego, CA (US); Sungha CHOI, Goyang-si (KR); Kyu Woong HWANG, Daejeon (KR); Fatih Murat PORIKLI, San Diego, CA (US)

(21) Appl. No.: 18/897,507

(22) Filed: Sep. 26, 2024

(51) Int. Cl. G06T 5/60; G06T 5/50; G06T 5/73; G06T 11/60

(52) U.S. Cl. CPC G06T 5/60; G06T 5/50; G06T 5/73; G06T 11/60; G06T 2207/20081; G06T 2207/20084

(57) ABSTRACT

Systems and techniques are described herein for fine-tuning a machine learning model. For example, a computing device can determine a plurality of sensitivity scores based on a query to edit a first image. Each respective sensitivity score of the plurality of sensitivity scores can be associated with a respective layer of a plurality of layers of a machine learning model. The computing device can apply an adapter to one or more layers of the plurality of layers that have a respective sensitivity score greater than a sensitivity threshold. The computing device can fine-tune parameters of the one or more layers based on application of the adapter to the one or more layers.

### TECHNICAL FIELD

The present disclosure generally relates to using selective adaptation for generative machine learning models. For example, aspects of the disclosure relate to systems and techniques for using selective adaptation (e.g., applying selective adapters) in generative machine learning models (e.g., text to image generation models) to enhance domain alignment (e.g., domain alignment between training data and a target domain of the text to image generation model).

### BACKGROUND

Machine learning models for performing perception tasks, such as object detection, image generation, etc., often require large training datasets to accurately perform perception tasks. Training a machine learning model on insufficient training samples can result in the machine learning model memorizing the training samples and thereby reducing the quality of the machine learning model outputs. Generating appropriately sized training datasets of images (e.g., large enough datasets to train machine learning models) can be a resource intensive task, especially when the training datasets require dense annotations. For example, many machine learning models for performing perception tasks use training datasets with pixel-wise annotations. Some alternatives to generating training datasets manually includes using a pre-trained text to image generation model, however these text to image generation models generally are generic models not trained for user specific requests.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In some aspects, an apparatus for fine-tuning machine learning models is provided. The apparatus includes at least one memory and at least one processor coupled to the at least one memory and configured to: determine a plurality of sensitivity scores based on a query to edit a first image, wherein each respective sensitivity score of the plurality of sensitivity scores is associated with a respective layer of a plurality of layers of a machine learning model; apply an adapter to one or more layers of the plurality of layers that have a respective sensitivity score greater than a sensitivity threshold; and fine-tune parameters of the one or more layers based on application of the adapter to the one or more layers.

In some aspects, a method for fine-tuning machine learning models is provided. The method includes: determining a plurality of sensitivity scores based on a query to edit a first image, wherein each respective sensitivity score of the plurality of sensitivity scores is associated with a respective layer of a plurality of layers of a machine learning model; applying an adapter to one or more layers of the plurality of layers that have a respective sensitivity score greater than a sensitivity threshold; and fine-tuning parameters of the one or more layers based on application of the adapter to the one or more layers.

In some aspects, a non-transitory computer-readable medium is provided having stored thereon instructions that, when executed by at least one processor, cause the at least one processor to: determine a plurality of sensitivity scores based on a query to edit a first image, wherein each respective sensitivity score of the plurality of sensitivity scores is associated with a respective layer of a plurality of layers of a machine learning model; apply an adapter to one or more layers of the plurality of layers that have a respective sensitivity score greater than a sensitivity threshold; and fine-tune parameters of the one or more layers based on application of the adapter to the one or more layers.

In some aspects, an apparatus for fine-tuning machine learning models is provided. The apparatus includes: means for determining a plurality of sensitivity scores based on a query to edit a first image, wherein each respective sensitivity score of the plurality of sensitivity scores is associated with a respective layer of a plurality of layers of a machine learning model; means for applying an adapter to one or more layers of the plurality of layers that have a respective sensitivity score greater than a sensitivity threshold; and means for fine-tuning parameters of the one or more layers based on application of the adapter to the one or more layers.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

FIG. 1 illustrates an example implementation of a neural network using a system-on-a-chip (SOC), including a general-purpose processor in accordance with certain aspects of the present disclosure.

FIGS. 2A, 2B, and 2C are diagrams illustrating a neural network in accordance with aspects of the present disclosure.

FIG. 2D is a diagram illustrating an exemplary deep convolutional network (DCN) in accordance with aspects of the present disclosure.

FIG. 3 is a block diagram illustrating an exemplary deep convolutional network (DCN) in accordance with aspects of the present disclosure.

FIG. 4 is a block diagram illustrating an exemplary software architecture that can modularize artificial intelligence (AI) functions, in accordance with aspects of the present disclosure.

FIG. 5 is a block diagram illustrating an example of augmented captions for sensitivity score generation, in accordance with aspects of the present disclosure.

FIG. 6 is a block diagram illustrating an example of applying selective low rank adaptation (LoRA) to projection layers of a machine learning model, in accordance with aspects of the present disclosure.

FIG. 7A is a block diagram illustrating an example of applying a selective LoRA adapter to layers of a machine learning model, in accordance with aspects of the present disclosure.

FIG. 7B is a block diagram illustrating an example of applying a partial LoRA adapter to layers of a machine learning model, in accordance with aspects of the present disclosure.

FIG. 7C is a block diagram illustrating an example of applying a partially selective LoRA adapter to layers of a machine learning model, in accordance with aspects of the present disclosure.

FIG. 8 is a block diagram illustrating head-wise parameter-efficient fine tuning, in accordance with aspects of the present disclosure.

FIG. 9 is a flow diagram for an example process for performing selective adaptation of a machine learning model, in accordance with aspects of the present disclosure.

FIG. 10 is a block diagram illustrating an example computing-device architecture of an example computing device which can implement the various techniques described herein.

### DETAILED DESCRIPTION

The detailed description set forth below, in connection with the appended drawings, is intended as a description of various configurations and is not intended to represent the only configurations in which the concepts described may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus can be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used to mean “serving as an example, instance, or illustration.” Any aspect described as “exemplary” is not necessarily to be construed as preferred or advantageous over other aspects.

Although particular aspects are described, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks, and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

As noted previously, machine learning models for performing perception tasks, such as object detection, semantic segmentation, etc., often require large training datasets to perform perception tasks. Training a machine learning model on insufficient training samples can result in biased outputs. Datasets to be used in training machine learning models for perception tasks (e.g., object detection, image editing, object insertion, etc.) can be difficult to generate. The datasets oftentimes must include a high quantity of images to effectively train the machine learning model. Manually creating the images is resource intensive and tedious. Further, the training data used by machine learning models for perception tasks is generally densely annotated. For example, many machine learning models rely on training data with pixel-wise annotations.

Generating datasets with pre-trained text to image generation models can sometimes save developers time and resources in procuring or building datasets for training. Text to image generation models (e.g., machine learning models for text to image generation) can sometimes include a label generator (e.g., a machine learning model) to provide annotations of features for images generated by the text to image generation models.

Some label generators, when used with an image generation model, can be adapted to parse semantic regions (e.g., in performing semantic segmentation) of images to generate segmentation datasets using only a few image-label pairs in training because the label generators are generally already trained on large training datasets. For example, some machine learning models can be optimized using parameter-efficient fine tuning (PEFT) to customize the label generators and image generation models. Optimization techniques using PEFT generally adapt a subset of weights or parameters of layers of machine learning models. PEFT techniques can include low-rank adaptations, such as by applying low-rank adaptation (LoRA) adapters, to reduce the number of parameters or weights that are adjusted when fine-tuning a machine learning model. Adapting machine learning models using PEFT techniques can save computational resources and memory usage by potentially avoiding the need to fully retrain a machine learning model to perform additional tasks.

Low rank adaptation (LoRA) can include techniques for reducing the number of trainable parameters of a machine learning model (e.g., weights of a neural network model). For example, applying LoRA techniques can include applying a LoRA adapter to a machine learning model (e.g., neural network model) to adjust which weights (and in some cases other parameters, such as biases) of the machine learning model can be fine-tuned. By reducing the number of trainable parameters, the fine-tuning process can save computational resources over retraining a machine learning model.

Image generation models generally do not ensure domain alignment between the desired target domain (e.g., urban-scene viewpoint with various styles and structures) images and the images generated for segmentation datasets. When fine-tuning all parameters of an image generation model with LoRA, the image generator generally captures all information, including undesired concepts (e.g., style, structure) from the training data. Capturing too much information can lead to overfitting and memorization of the training data. The lack of domain alignment between desired target domain images and generated images is problematic because training a perception model using generated images with unaligned domains does not provide sufficient information. For example, a perception machine learning model can learn more by using images generated with diverse styles and structures that align with only the viewpoint while being free from the limited information of the original training data. Using training data with aligned domains allows a robust perception model to be trained to withstand different lighting, styles, or other environmental conditions.

Systems, apparatuses, electronic devices, methods (also referred to as processes), and computer-readable media (collectively referred to herein as “systems and techniques”) are described herein for improving domain-alignment of images generated for training datasets by fine-tuning a machine learning model. In some aspects, the machine learning model can be fine tuned to generate images demonstrating domain alignment with a previous image. For example, the machine learning model can be a generative model. In some examples, the machine learning model is a text to image machine learning model.

The machine learning model can receive a first image and a first caption associated with the first image. The first caption can be a text description of the first image. For example, the first image can be a first-person perspective view of an urban street. In such an example, the first caption can be a sentence (e.g., a string) “Photorealistic first-person urban street view”. In some examples, the machine learning model can be an image generation model with a label generator. The image generator model can generate an image from the first caption as input, and the label generator can produce pixel-wise annotations for the generated image. In some examples, the first caption can be provided by a user. For example, the user can provide a query to the text-to-image generation model to generate the image.

In some aspects, the systems and techniques can receive a second query from a user. The query can include a request to augment features of the first image. In some examples, the query can be, or can include, a text caption describing augmentations (also referred to as edits) to the first image to be applied by the machine learning model when generating a second image. In some examples the second query can be provided as input to the machine learning model to generate the second image. For example, the query can be a sentence describing augmentations to features of the first image. The sentence can include augmentations to the perspective of a scene represented in the image. In continuing the previous example of a first image and first caption “Photorealistic first-person urban street view”, the second caption can be a string “Photorealistic urban street in top-down view” to request augmenting the first image to change the perspective of the image from first person to an aerial view. The second caption can include descriptions for other angles such “high angle view” and “low angle view” to request augmentation of the perspective view of the first image.

Further examples include augmentations to the first image regarding an art style of the first image. For example, the second caption can be the string “Watercolor first-person urban street view” requesting the art style of the first image be augmented to resemble a watercolor drawing. In another example, the second caption can be the string “Sketch first-person urban street view” to request a black and white or grayscale rendering of the first image resembling a drawing created using a pencil. In further examples, the second text caption can request insertion of objects into the first image. For example, the second caption can be “Photorealistic first-person urban street view with car” to request insertion of a car in the first image. In some aspects, the second caption can include requests to augment the first image with multiple changes. For example, the first image can be a “Photorealistic first-person urban street view” as stated in the first caption. The second caption can request changes in perspective, art style, and the addition of an object by including “Watercolor urban street with car in top-down view”.

In some aspects, the second query can be an augmented representation of the first query. For example, the first query can include the caption “Photorealistic urban street in high angle view”. The second query can include the caption “Watercolor urban street in high angle view”. The machine learning model can generate a first image associated with the first query and generate a second image associated with the second query.

In some aspects, the systems and techniques can add noise to the first image. For example, the systems and techniques can apply a filter to the first image. In some examples, the filter can introduce random noise in the first image. The systems and techniques can compare the first image with noise to the first image without noise. The systems and techniques can further compare the first image with noise to the image generated by the machine learning model associated with the second query (e.g., the query with an augmented caption). The systems and techniques can determine a denoising direction associated with removing the noise from the first image with noise to generate the first image and a denoising direction associated with removing the noise from the first image to generate the second image with the second query. In some examples, the machine learning model can predict denoising directions with the first query and the second query.

In some aspects, denoising direction can refer to the machine learning model predicting how to remove noise step by step, guided by the first query to reconstruct the first image. For example, in a text-to-image generation model such as stable diffusion, the denoising direction refers to the model predicting how to remove noise step by step, guided by the first query to reconstruct the image. Denoising refers to the process of gradually removing the noise. More denoising steps can allow for finer adjustments to the noise, resulting in higher-quality images. In further aspects, when the caption is augmented, the denoising direction can change accordingly, leading to variations in the generated images. Denoising can transform noisy data into coherent images based on the first query or the second query.

In some aspects, the systems and techniques can calculate sensitivity scores associated with the denoising direction and differences between the denoising direction of the first image with the original caption and the second image with the augmented caption. The sensitivity scores can be associated with one or more layers of the machine learning model that generated the first image and the second image. An objective function can be used to identify weights sensitive to a desired concept (e.g., the augmentations of the augmented caption). The object function can encourage the machine learning model (e.g., a generative model) to modify the concept by providing a significant gradient for concept-sensitive weights. For example, if the objective function instructs the image generation model to alter the viewpoint, the viewpoint-sensitive weights will receive large gradients. The sensitivity scores can represent a level of sensitivity of layers of the machine learning model to augmentations to the first query. For example, parameters of layers more sensitive (e.g., showing more change in values) can be identified by observing gradients of the machine learning model. In some examples, the sensitivity scores are a value representation of layers or individual parameters of layers that demonstrate greater amounts of change based on augmentations to the first query. In some examples, the systems and techniques can calculate the increased ratio between the augmented gradients and the original diffusion gradients to eliminate the bias of the gradients that the shallow layers receive larger gradients than the deeper layers.

In some aspects, the sensitivity scores can be normalized by calculating the ratio of gradients between an original ground truth of the machine learning model (e.g., the first image without the added noise) and an augmented ground truth (e.g., the first image with the added noise). In some examples, the normalization of the sensitivity scores can be used to reduce bias of gradients at shallower layers which can often receive larger gradients than deeper layers of the machine learning model.

In some aspects, the systems and techniques can fine tune the machine learning model based on the sensitivity scores. For example, the systems and techniques can compare the sensitivity scores to a sensitivity threshold. The sensitivity threshold can represent a threshold which when exceeded, demonstrates that a layer or parameter associated with the layer should be fine-tuned. For example, the sensitivity threshold can represent a boundary between layers or parameters determined to be high-sensitivity and low-sensitivity. High-sensitivity layers are layers with higher gradient changes when used to generate an image using the augmented caption. In some examples, the sensitivity threshold can vary based on the sensitivity scores. For example, the sensitivity threshold can be relative to the sensitivity scores calculated based on the second query (e.g., the augmented caption, augmented query). In such an example, the sensitivity threshold can be higher when the sensitivity scores are higher, and the sensitivity threshold can lower when the sensitivity scores are lower. In some examples, the sensitivity threshold is based on a percentage of sensitivity scores falling below the sensitivity threshold. For example, the sensitivity threshold can be set to a value which is higher than 80% of the sensitivity scores. For example, the high-sensitivity layers of the machine learning model can be set as the top 20% of sensitivity scores associated with the layers.

In some aspects, the systems and techniques can apply adapter (e.g., low-ranking adaptation (LoRA)) techniques for fine-tuning the machine learning model. For examples, fine-tuning the machine learning model can include applying an adapter (e.g., a LoRA adapter) to weights or parameters of the machine learning model. In some examples, the adapter can be a selective LoRA adapter. For example, the adapter (e.g., the selective LoRA adapter) can be applied to only a few parameters or weights of a layer. In further examples, the adapter can be a partial LoRA adapter. For example, the adapter (e.g., the partial LoRA adapter) can be applied to only a few layers of the machine learning model, such as the deeper layers. In some examples, the adapter can be a partially selective LoRA. For example, the adapter (e.g., the partially selective LoRA adapter) can be applied to only a few parameters or weights of the deeper layers of the machine learning model. In some examples, the adapter techniques can be applied head-wise to the machine learning model. For example, the systems and techniques can apply an adapter (e.g., the LoRA adapter) at individual weights or parameters of the machine learning model. While examples described herein use a LoRA adapter for illustrative purposes, other types of adapters can be applied by the systems and techniques described herein. For example, various adapters able to apply parameter-efficient fine-tuning (PEFT) to machine learning models can be used.

Various aspects of the application will be described with respect to the figures below.

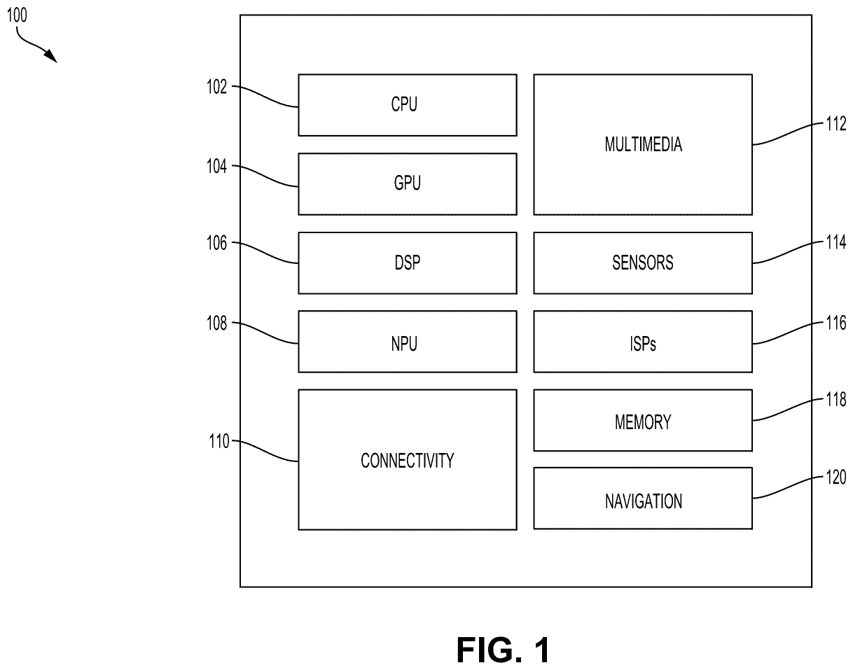

FIG. 1 illustrates an example implementation of a system-on-a-chip (SOC) 100, which may include a central processing unit (CPU) 102 or a multi-core CPU configured for selective parameter efficient fine-tuning. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a memory block 118, or may be distributed across multiple blocks. Instructions executed at the CPU 102 may be loaded from a program memory (e.g., at least one memory coupled to the CPU or other component) associated with the CPU 102 or may be loaded from a memory block 118.

The SOC 100 may also include additional processing blocks tailored to specific functions, such as a GPU 104, a DSP 106, a connectivity block 110, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU 108 is implemented in the CPU 102, DSP 106, GPU 104, or a general-purpose processor. The SOC 100 may also include a sensor processor 114, image signal processors (ISPs) 116, and/or navigation module 120, which may include a global positioning system.

The SOC 100 may be based on an ARM, RISC-V (RISC-five), or any reduced instruction set computing (RISC) architecture. In aspects of the present disclosure, the instructions loaded into the general-purpose processor (or CPU 102) can include code to receive a large language model (LLM), the LLM having multiple layers, each layer having a set of parameters. The instructions loaded into the general-purpose processor, or CPU 102, can also include code identify a subset of the parameters to fine-tune for a downstream task based on a score function. The instructions loaded into the general-purpose processor, or CPU 102, can additionally include code apply an adapter to the identified subset of the parameters to fine-tune. The instructions loaded into the general-purpose processor, or CPU 102, can further include code fine-tune only the identified subset of the parameters.

Deep learning architectures can perform an object recognition task by learning to represent inputs at successively higher levels of abstraction in each layer, thereby building up a useful feature representation of the input data. In this way, deep learning addresses a major bottleneck of traditional machine learning. Prior to the advent of deep learning, a machine learning approach to an object recognition problem may have relied heavily on human engineered features, perhaps in combination with a shallow classifier. A shallow classifier may be a two-class linear classifier, for example, in which a weighted sum of the feature vector components may be compared with a threshold to predict to which class the input belongs. Human engineered features may be templates or kernels tailored to a specific problem domain by engineers with domain expertise. Deep learning architectures, in contrast, may learn to represent features that are similar to what a human engineer might design, but through training. Furthermore, a deep network may learn to represent and recognize new types of features that a human might not have considered.

A deep learning architecture can learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures can perform especially well when applied to problems that have a natural hierarchical structure. For example, the classification of motorized vehicles can benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

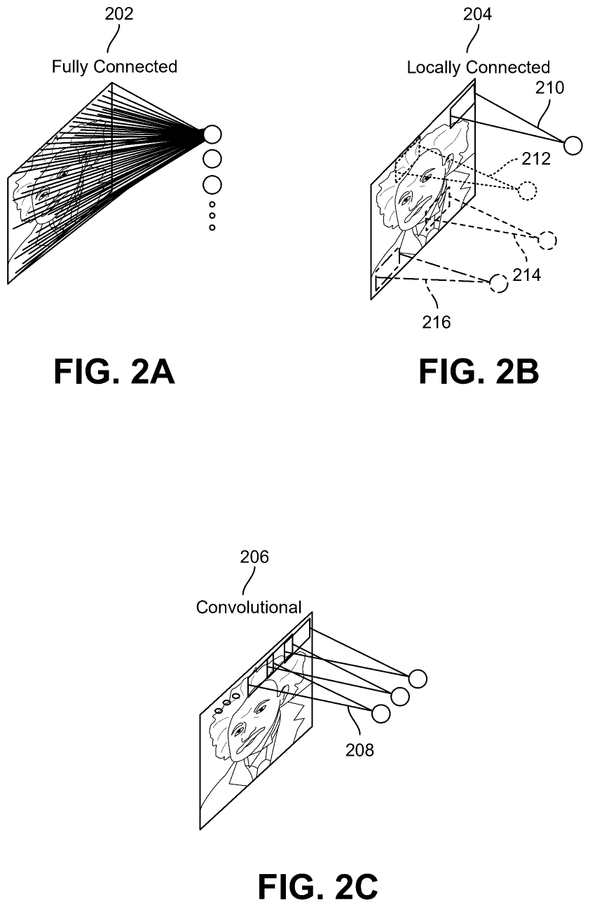

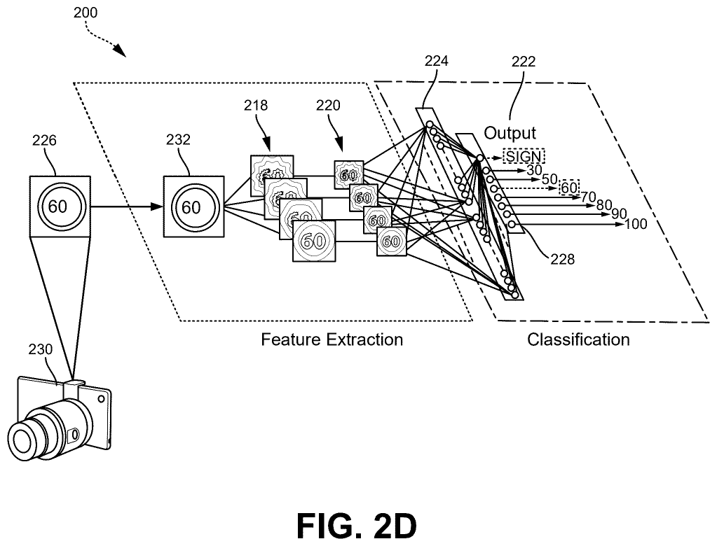

The connections between layers of a neural network may be fully connected or locally connected. FIG. 2A illustrates an example of a fully connected neural network 202. In a fully connected neural network 202, a neuron in a first layer may communicate its output to every neuron in a second layer, so that each neuron in the second layer will receive input from every neuron in the first layer. FIG. 2B illustrates an example of a locally connected neural network 204. In a locally connected neural network 204, a neuron in a first layer may be connected to a limited number of neurons in the second layer. More generally, a locally connected layer of the locally connected neural network 204 may be configured so that each neuron in a layer will have the same or a similar connectivity pattern, but with connections strengths that may have different values (e.g., 210, 212, 214, and 216). The locally connected connectivity pattern may give rise to spatially distinct receptive fields in a higher layer because the higher layer neurons in a given region may receive inputs that are tuned through training to the properties of a restricted portion of the total input to the network.

One example of a locally connected neural network is a convolutional neural network. FIG. 2C illustrates an example of a convolutional neural network 206. The convolutional neural network 206 may be configured such that the connection strengths associated with the inputs for each neuron in the second layer are shared (e.g., 208). Convolutional neural networks may be well suited to problems in which the spatial location of inputs is meaningful.

One type of convolutional neural network is a deep convolutional network (DCN). FIG. 2D illustrates a detailed example of a DCN 200 designed to recognize visual features from an image 226 input from an image capturing device 230, such as a car-mounted camera. The DCN 200 of the current example may be trained to identify traffic signs and a number provided on the traffic sign. Of course, the DCN 200 may be trained for other tasks, such as identifying lane markings or identifying traffic lights.

The DCN 200 may be trained with supervised learning. During training, the DCN 200 may be presented with an image, such as the image 226 of a speed limit sign, and a forward pass may then be computed to produce an output 222. The DCN 200 may include a feature extraction section and a classification section. Upon receiving the image 226, a convolutional layer 232 may apply convolutional kernels (not shown) to the image 226 to generate a first set of feature maps 218. As an example, the convolutional kernel for the convolutional layer 232 may be a 5×5 kernel that generates 28×28 feature maps. In the present example, because four different feature maps are generated in the first set of feature maps 218, four different convolutional kernels were applied to the image 226 at the convolutional layer 232. The convolutional kernels may also be referred to as filters or convolutional filters.

The first set of feature maps 218 may be subsampled by a max pooling layer (not shown) to generate a second set of feature maps 220. The max pooling layer reduces the size of the first set of feature maps 218. That is, a size of the second set of feature maps 220, such as 14×14, is less than the size of the first set of feature maps 218, such as 28×28. The reduced size provides similar information to a subsequent layer while reducing memory consumption. The second set of feature maps 220 may be further convolved via one or more subsequent convolutional layers (not shown) to generate one or more subsequent sets of feature maps (not shown).

In the example of FIG. 2D, the second set of feature maps 220 is convolved to generate a first feature vector 224. Furthermore, the first feature vector 224 is further convolved to generate a second feature vector 228. Each feature of the second feature vector 228 may include a number that corresponds to a possible feature of the image 226, such as “sign,” “60,” and “100.” A softmax function (not shown) may convert the numbers in the second feature vector 228 to a probability. As such, an output 222 of the DCN 200 may be a probability of the image 226 including one or more features.

In the present example, the probabilities in the output 222 for “sign” and “60” are higher than the probabilities of the others of the output 222, such as “30,” “40,” “50,” “70,” “80,” “90,” and “100”. Before training, the output 222 produced by the DCN 200 may likely be incorrect. Thus, an error may be calculated between the output 222 and a target output. The target output is the ground truth of the image 226 (e.g., “sign” and “60”). The weights of the DCN 200 may then be adjusted so the output 222 of the DCN 200 is more closely aligned with the target output.

To adjust the weights, a learning algorithm may compute a gradient vector for the weights. The gradient may indicate an amount that an error would increase or decrease if the weight were adjusted. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted to reduce the error. This manner of adjusting the weights may be referred to as “back propagation” as it involves a “backward pass” through the neural network. For example, backpropagation techniques may be used to train an ANN by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level. After learning, the DCN 200 may be presented with new images (e.g., the speed limit sign of the image 226) and a forward pass through the DCN 200 may yield an output 222 that may be considered an inference or a prediction of the DCN 200.

An optimization algorithm may be used during a training process to adjust weights and biases as needed to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an on-going training process early, such as when a performance of the model using a validation dataset starts to degrade.

Deep belief networks (DBNs) are probabilistic models comprising multiple layers of hidden nodes. DBNs may be used to extract a hierarchical representation of training data sets. A DBN may be obtained by stacking up layers of Restricted Boltzmann Machines (RBMs). An RBM is a type of artificial neural network that can learn a probability distribution over a set of inputs. Because RBMs can learn a probability distribution in the absence of information about the class to which each input should be categorized, RBMs are often used in unsupervised learning. Using a hybrid unsupervised and supervised paradigm, the bottom RBMs of a DBN may be trained in an unsupervised manner and may serve as feature extractors, and the top RBM may be trained in a supervised manner (on a joint distribution of inputs from the previous layer and target classes) and may serve as a classifier.

DCNs are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer, with each element of the feature map (e.g., 220) receiving input from a range of neurons in the previous layer (e.g., feature maps 218) and from each of the multiple channels. The values in the feature map may be further processed with a non-linearity, such as a rectification, max(0, x). Values from adjacent neurons may be further pooled, which corresponds to down sampling, and may provide additional local invariance and dimensionality reduction. Normalization, which corresponds to whitening, may also be applied through lateral inhibition between neurons in the feature map.

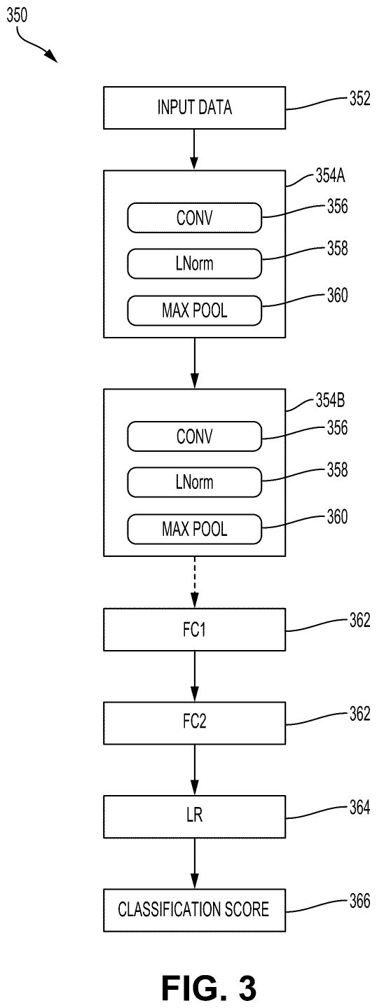

FIG. 3 is a block diagram illustrating a DCN 350. The DCN 350 may include multiple different types of layers based on connectivity and weight sharing. As shown in FIG. 3, the DCN 350 includes the convolution blocks 354A, 354B. Each of the convolution blocks 354A, 354B may be configured with a convolution layer (CONV) 356, a normalization layer (LNorm) 358, and a max pooling layer (MAX POOL) 360.

Although only two of the convolution blocks 354A, 354B are shown, the present disclosure is not so limiting, and instead, any number of the convolution blocks 354A, 354B may be included in the DCN 350 according to design preference.

The convolution layers 356 may include one or more convolutional filters, which may be applied to the input data to generate a feature map. The normalization layer 358 may normalize the output of the convolution filters. For example, the normalization layer 358 may provide whitening or lateral inhibition. The max pooling layer 360 may provide down sampling aggregation over space for local invariance and dimensionality reduction.

The parallel filter banks, for example, of a deep convolutional network may be loaded on a CPU 102 or GPU 104 of an SOC 100 (e.g., FIG. 1) to achieve high performance and low power consumption. In alternative embodiments, the parallel filter banks may be loaded on the DSP 106 or an ISP 116 of an SOC 100. In addition, the DCN 350 may access other processing blocks that may be present on the SOC 100, such as sensor processor 114 and navigation module 120, dedicated, respectively, to sensors and navigation.

The DCN 350 may also include one or more fully connected layers 362 (FC1 and FC2). The DCN 350 may further include a logistic regression (LR) layer 364. Between each layer 356, 358, 360, 362, 364 of the DCN 350 are weights (not shown) that are to be updated. The output of each of the layers (e.g., 356, 358, 360, 362, 364) may serve as an input of a succeeding one of the layers (e.g., 356, 358, 360, 362, 364) in the DCN 350 to learn hierarchical feature representations from input data 352 (e.g., images, audio, video, sensor data and/or other input data) supplied at the first of the convolution blocks 354A. The output of the DCN 350 is a classification score 366 for the input data 352. The classification score 366 may be a set of probabilities, where each probability is the probability of the input data including a feature from a set of features.

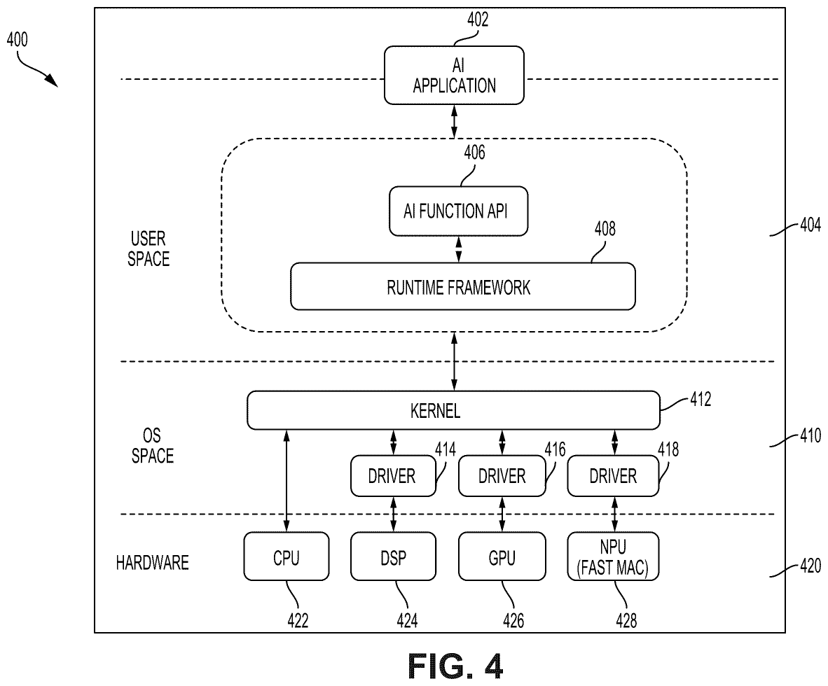

FIG. 4 is a block diagram illustrating an exemplary software architecture 400 that may modularize artificial intelligence (AI) functions. Using the architecture 400, applications may be designed that may cause various processing blocks of an SOC 420 (for example a CPU 422, a DSP 424, a GPU 426 and/or an NPU 428) (which may be similar to SOC 100 of FIG. 1) to support selective parameter-efficient fine-tuning for an AI application 402, according to aspects of the present disclosure. The architecture 400 may, for example, be included in a computational device, such as a smartphone.

The AI application 402 may be configured to call functions defined in a user space 404 that may, for example, provide for the detection and recognition of a scene indicative of the location at which the computational device including the architecture 400 currently operates. The AI application 402 may, for example, configure a microphone and a camera differently depending on whether the recognized scene is an office, a lecture hall, a restaurant, or an outdoor setting such as a lake. The AI application 402 may make a request to compiled program code associated with a library defined in an AI function application programming interface (API) 406. This request may ultimately rely on the output of a deep neural network configured to provide an inference response based on video and positioning data, for example.

The run-time engine 408, which may be compiled code of a runtime framework, may be further accessible to the AI application 402. The AI application 402 may cause the run-time engine 408, for example, to request an inference at a particular time interval or triggered by an event detected by the user interface of the AI application 402. When caused to provide an inference response, the run-time engine 408 may in turn send a signal to an operating system in an operating system (OS) space 410, such as a Kernel 412, running on the SOC 420. In some examples, the Kernel 412 may be a LINUX Kernel. The operating system, in turn, may cause a selective parameter efficient fine-tuning (PEFT) to be performed on the CPU 422, the DSP 424, the GPU 426, the NPU 428, or some combination thereof. The CPU 422 may be accessed directly by the operating system, and other processing blocks may be accessed through a driver, such as a driver 414, 416, or 418 for, respectively, the DSP 424, the GPU 426, or the NPU 428. In the exemplary example, the deep neural network may be configured to run on a combination of processing blocks, such as the CPU 422, the DSP 424, and the GPU 426, or may be run on the NPU 428.

As described, aspects of the present disclosure are directed to parameter efficient fine-tuning of a machine learning model for text to image generation. In various aspects, more important connections can be identified for each downstream task. One or more adapters can be attached and employed to fine-tune the parameters and weights associated of layers associated with sensitivity scores below a sensitivity threshold. In turn, one or more adapters can be attached exclusively to the identified connections, allowing for fine-tuning.

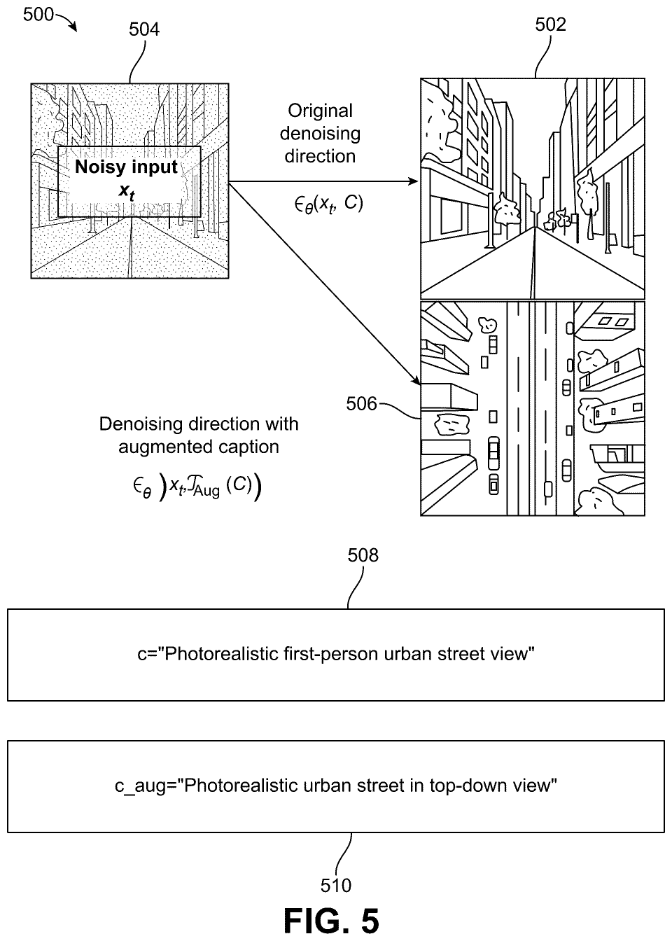

FIG. 5 is a block diagram illustrating an example 500 of augmented captions for sensitivity score generation using a machine learning model. The machine learning model can be a generative model such as a text to image generation model. Further description the machine learning model can be found in the descriptions of FIGS. 2-4. The block diagram includes a first image 502, a noisy image 504 and an augmented image 506. A machine learning model can generate the first image based on a first query 508 received by a user. For example, the first query 508 can include a text caption input by a user requesting the machine learning model generate an image with features stated in the text caption. For example, the text caption can be “Photorealistic first-person urban street view”. The machine learning model can generate the first image 502 based on the first query 508.

The machine learning model can receive a second query. The second query 510 can be an augmented query including an augmentation (e.g., an edit) to the first query. For example, the second query can include a text caption including description of an augmentation to the first image. The second query can be a request to augment the first image by changing a perspective of a scene in the first image 502, changing an art style of the first image 502, and adding an object to the first image 502. For example, the second query can include a text caption “Photorealistic urban street in top-down view” to request the machine learning model augment the first image to generate the augmented image 506 based on the second query 510.

The machine learning model can add noise (e.g., €) to the first image 502 to generate the noisy image 504. For example, the machine learning model can include apply a filter to the first image 502. In some examples, the filter can add random noise in the first image. In further examples, the machine learning model can perform a diffusion process (e.g., a forward diffusion process) to add noise to the first image 502 to generate the noisy image 504. The machine learning model can predict a denoising direction associated with the first query and the second query to identify sensitive layers, parameters, and weights of the machine learning model that are sensitive to the augmentation of the augmented image 506 and the second query 510.

In some examples, the machine learning model can generate multiple images (x₀). The machine learning model image and query generation can be represented by equations: x₀=φ_{T21}(c),zₜ=\sqrt{α̅ₜ}x₀+\sqrt{1−α̅ₜ}ϵ, where ϵ˜N(0,1). For example, φ_{T21} can represent the machine learning model. The machine learning model can be a pretrained generative model. Element t represents a pre-defined timestep and ϵ represents added noise.

The noise between the noisy image 504 and the first image 502 can be represented by ϵ(xₜ,x₀) with xₜ representing the noisy image 504 and x₀ representing the first image 502. The first query 508 can be represented by ϵ_{θ}(xₜ, c) with c representing the text caption associated with the first image 502 and the first query 508. The second query can be represented by ϵ_{θ}(xₜ, T_{Aug}(c)) with T_{Aug}(c) representing the augmentations of the second query 510 from the first query 508.

The machine learning model can determine losses associated with gradients representing changes from the noisy image 504 to the first image 502 and the augmented image 506. For example, the losses can be represented by

$${L}_{Concept - sensitive} = {‖ {ϵ}_{θ} ( {x}_{t} , c ) - sg [ {ϵ}_{θ} ( {x}_{t} , {c}_{Aug} ) ] ‖}_{2}^{2}$$

where sg represents a stop-gradient operation. The machine learning model can determine diffusion losses associated with the noisy image 504. For example, the diffusion losses can be represented by

$${L}_{Diffusion} = {‖ {ϵ}_{θ} ( {x}_{t} , c ) - ϵ ‖}_{2}^{2} .$$

The diffusion losses can represent losses from denoising the noisy image 504 (e.g., the difference in the machine learning model predictions of noise during a diffusion process).

The machine learning model can determine gradients of loss functions associated with the machine learning model when denoising the noisy image 504 and generating the augmented image 506. The machine learning model can generate sensitivity scores based on a ratio of the losses represented as Concept-Sensitivity

$$( θ ) = {𝔼}_{{x}_{t} , ϵ , {c}_{Aug}} [ \frac{{‖ {∇}_{θ} {L}_{Concept - sensitive} ‖}_{2}}{{‖ {∇}_{θ} {L}_{Diffusion} ‖}_{2}} ] .$$

Concept-Sensitivity (θ) represents the sensitivity scores. κ_{θ} represents a gradient function to be applied to L_{Diffusion} and L_{concept-sensitive}. For instance, according to the Concept-Sensitivity equation, sensitivity scores can be determined based on a gradient associated with a loss function representing differences between a noise prediction used to reconstruct an image from a first text caption and a noise prediction used to generate a second image from an augmented version of the first text caption. In some examples, the sensitivity scores are represented as a ratio of the loss functions to reduce bias of gradients in shallow layers of the machine learning models than can receive larger gradients than the deeper layers of the machine learning model.

The machine learning model can be fine-tuned based on the sensitivity scores. For example, the machine learning model can be fine-tuned at layers associated with sensitivity scores above (e.g., greater than) a sensitivity threshold. For example, the sensitivity threshold can represent a boundary between layers or parameters determined to be high-sensitivity and low-sensitivity. High-sensitivity layers are layers with higher gradient changes when used to generate the augmented image 506 using the second query 510. In some examples, the sensitivity threshold can vary based on the sensitivity scores. For example, the sensitivity threshold can be relative to the sensitivity scores calculated based on the second query 510. In some examples, the sensitivity threshold is based on a percentage of sensitivity scores falling below the sensitivity threshold. For example, the sensitivity threshold can be set to a value which is higher than 80% of the sensitivity scores. For example, the high-sensitivity layers of the machine learning model can be set as the top 20% of sensitivity scores associated with the layers. In some examples, the sensitivity scores can be normalized by calculating the ratio of gradients between an original ground truth of the machine learning model (e.g., the first image 502) and an augmented ground truth (e.g., the noisy image 504).

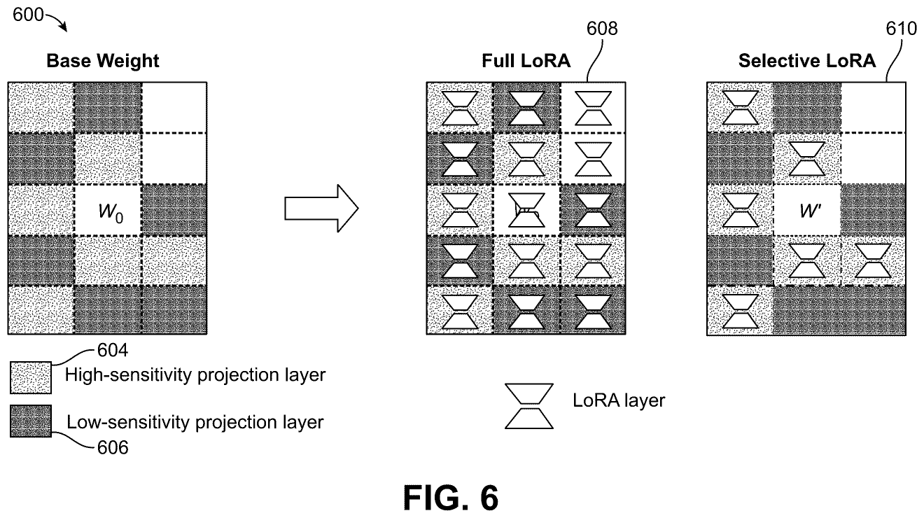

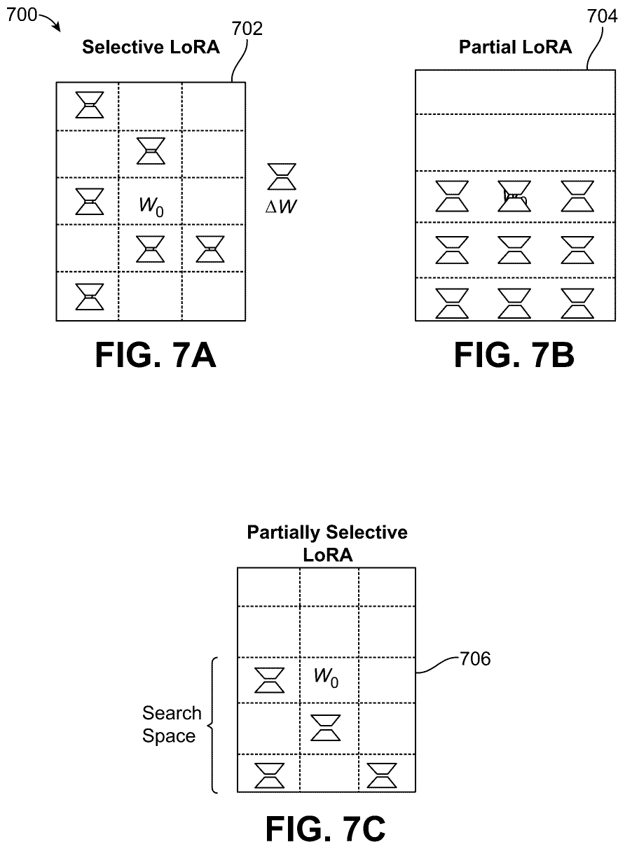

The machine learning model can be fine-tuned by applying an adapter to the layers of the machine learning model that are high-sensitivity layers based on the respective sensitivity score of the layers (e.g., layers with sensitivity scores greater than the sensitivity threshold). Further description of adapters that can be applied to fine-tune the machine learning model are provided in the descriptions of FIG. 6 and FIGS. 7A-7C.

FIG. 6 is a block diagram illustrating an example of applying an adapter to the high-sensitivity layers to fine-tune the machine learning model. In particular, FIG. 6 is a block diagram illustrating an example 600 of selective low rank adaptation (LoRA) to projection layers of a machine learning model. The selective low rank adaptation (LoRA) can be applied to projection layers of the machine learning model associated with sensitivity score greater than the sensitivity threshold. For example, layers of a base weight machine learning model 602 (e.g., a machine learning model without an applied LoRA adapter) can be identified as high-sensitivity layers 604 or low-sensitivity layers 606 based on calculated sensitivity scores.

Low rank adaptation (LoRA) can include techniques reducing the number of trainable parameters of a machine learning mode. For example, applying LoRA techniques can include applying a LoRA adapter to a machine learning model to adjust which weights and parameters of the machine learning model can be fine-tuned. A full LoRA machine learning model 608 is shown with LoRA adapters applied to each layer of the full LoRA machine learning model 608. In a full LoRA machine learning model 608, the LoRA adapter is applied to each layer of the machine learning model adjusting which weights and parameters of each layer can be fine-tuned.

A selective LoRA machine learning model 610 is shown with LoRA adapters applied to only the layers of the machine learning model that are high-sensitivity layers 604 (e.g., layers of the machine learning model with sensitivity scores exceeding the sensitivity threshold). Further description of sensitivity scores and the sensitivity thresholds are provided in the description of FIG. 5. The weights and parameters of the high-sensitivity layers of the selective LoRA machine learning model can be fine-tuned (e.g., adjusted) based on the sensitivity score to minimize a loss function. By updating the weights and parameters of the high-sensitivity layers, the machine learning model can be adjusted to maintain generalizability of the augments (e.g., edits to the images requested in the second query of FIG. 5) applied to the first image. Maintaining generalizability of the augments improves domain alignment between images generated by the machine learning model, making the machine learning model more useful when generating training datasets.

FIGS. 7A-7C are a set of block diagrams 700 demonstrating an application of different types of LoRA adapters. In particular, FIG. 7A is a block diagram illustrating an example of applying selective parameter efficient (e.g., selective LoRA) adapters at layers (e.g., projection layers) of a machine learning model to fine-tune the machine learning model. As shown in FIG. 7A, a selective LoRA adapter 702 can be applied to different layers of a machine learning model. The selective LoRA adapter 702 can be applied to different layers throughout the entirety of the machine learning model. For example, a selective LoRA adapter 702 can be used to fine-tune parameters at both shallow layers and deep layers of the machine learning model. The selective LoRA adapter 702 can be applied to individual parameters of layers of the machine learning model. For example, a layer can have three parameters. The selective LoRA adapter 702 can be applied to one of the three parameters, two of the three parameters, or all three parameters to fine-tune the machine learning at the layer.

FIG. 7B is a block diagram illustrating an example of applying a partial LoRA adapter 704 to layers of a machine learning model. The partial LoRA adapter 704 is only applied at layers of the machine learning model within a preset search space. For example, the partial LoRA adapter 704, the preset search space is applied to three lower layers of the machine learning model. In some examples, such as shown in FIG. 7B, the partial LoRA adapter 704 can be applied to all weights and parameters of a layer.

FIG. 7C is a block diagram illustrating an example of applying a partially selective LoRA adapter 706 to layers of a machine learning model. The partially selective LoRA adapter 706 is applied to individual weights and parameters of layers within a search space of the machine learning model. For example, to save on computational resources, sensitivity scores (e.g., the sensitivity scores further described in the description of FIG. 5) can be calculated for only a subset of layers of a machine learning model. The partially selective LoRA adapter 706 can be applied to the individual weights and parameters of layers within the subset of layers.

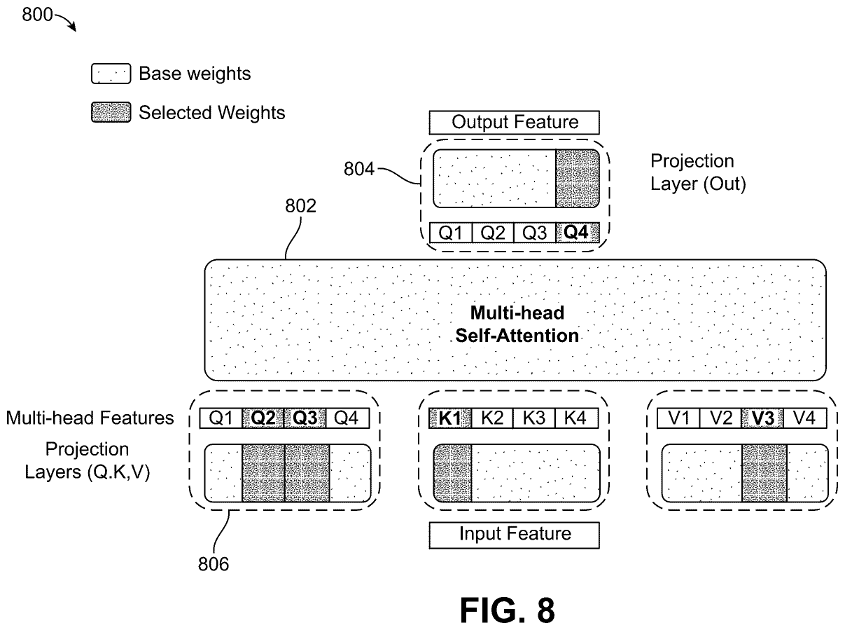

FIG. 8 is a block diagram illustrating a system 800 for head-wise parameter-efficient fine tuning. For example, the block diagram includes a multi-head self-attention engine 802 of a transformer. In a convolutional neural network (CNN) model, the number of operations required to relate signals from two arbitrary input or output positions grows in the distance between positions, which makes learning dependencies at different distant positions challenging for a CNN model. A transformer reduces the operations of learning dependencies by using an encoder and a decoder that implement an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key. FIG. 8 illustrates a part of a transformer at the multi-head self-attention engine 802

Queries, keys, and values (e.g., at input projection layer 806) can be linearly projected by the multi-head self-attention engine into learned linear projects, and then attention is performed in parallel on each of the learned linear projects, which are concatenated and then projected into final values (e.g., at output projection layer 804). FIG. 8 illustrates how a LoRA adapter (e.g., a selective LoRA adapter 702 or partially selective LoRA adapter 706 from FIGS. 7A and 7C) can be applied head-wise to individual attention heads within a multi-head attention mechanism to fine-tune individual weights and parameters of the machine learning model. In some examples, the LoRA adapter can be applied head-wise to attention heads at the input projection layer 806. In further examples, the LoRA adapter can be applied head-wise to attention heads at the output projection layer.

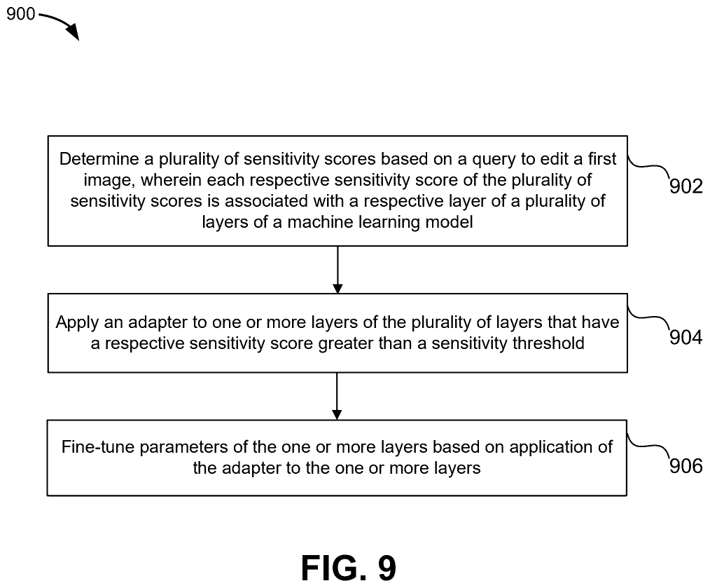

FIG. 9 is a flow diagram illustrating an example process 900 for fine-tuning a machine learning model, in accordance with aspects of the present disclosure. One or more operations of process 900 can be performed by a computing device (or apparatus) or a component (e.g., the SOC 100 of FIG. 1, any one or more of the networks 200, 202, 204, and/or 206 of FIGS. 2A-2D, the network 350 of FIG. 3, a system having the architecture 400 of FIG. 4, the system 800 of FIG. 8, one or more chipsets, one or more processors such as one or more CPUs, DSPs, NPUs, neural signal processors (NSPs), microcontrollers, application specific integrated circuits (ASICs), field programmable logic arrays (FPGAs), programmable logic devices, discrete gates or transistor logic components, discrete hardware components, etc., an ML system such as a neural network model, any combination thereof, and/or other component or system) of the computing device. The computing device can be a mobile device (e.g., a mobile phone), a network-connected wearable such as a watch, an extended reality (XR) device such as a virtual reality (VR) device or augmented reality (AR) device, a vehicle or component or system of a vehicle, a desktop computing device, a tablet computing device, a server computer, a robotic device, and/or any other computing device with the resource capabilities to perform the process 900. The one or more operations of process 900 can be implemented as software components that are executed and run on one or more processors.

At block 902, the computing device (or component thereof) can determine a plurality of sensitivity scores based on a query to edit a first image. Each respective sensitivity score of the plurality of sensitivity scores is associated with a respective layer of a plurality of layers of a machine learning model. For example, the computing device (or component thereof) can use one or more of the machine learning models described in the descriptions of FIGS. 2A-2C and FIG. 3 to determine the sensitivity scores based on the query.

In some aspects, the computing device (or component thereof) can generate the first image using the machine learning model. For example, the machine learning model can receive a first text caption as an input and add noise to the first image to reconstruct the first image. The machine learning model can determine the plurality of sensitivity scores based on a gradient associated with a loss function representing differences between a noise prediction used to reconstruct the first image from the first text caption and a noise prediction used to generate a second image from an augmented version of the first text caption (e.g., as illustrated in the Concept-Sensitivity equation noted above—Conceptsensivity

$$( θ ) = {𝔼}_{{x}_{t} , ϵ , {c}_{Aug}} [ \frac{{‖ {∇}_{θ} {L}_{Concept - sensitive} ‖}_{2}}{{‖ {∇}_{θ} {L}_{Diffusion} ‖}_{2}} ] ) .$$

In some cases, the machine learning model can determine the plurality of sensitivity scores based on a first gradient associated with a first loss function and a second gradient associated with a second loss function. In some aspects, the first loss function can represent the reconstruction of the first image from the first text caption. In further aspects, the second loss function can represent differences between the first image and a second image generated using a second text caption.

In some aspects, the augmented version of the first text caption includes a second caption (e.g., a second text caption). The second caption can include the first text caption augmented to include a description of features to be edited in the first image. In further aspects, the augmented version of the first text caption (e.g., the second text caption) can include a request to edit the first image by changing an art style of the first image or a perspective view of a scene associated with the first image.

At block 904, the computing device (or component thereof) can apply an adapter to one or more layers of the plurality of layers that have a respective sensitivity score greater than a sensitivity threshold. For example, the computing device (or component thereof) can apply a LoRA adapter, as further described in the descriptions of FIG. 6 and FIGS. 7A-7C. In some aspects, the adapter can be any adapter able to perform parameter-efficient fine tuning (PEFT). In further aspects, the LoRA adapter is applied head-wise to the one or more layers that have the respective sensitivity score greater than the sensitivity threshold. In some aspects, the sensitivity threshold is variable based on the plurality of sensitivity scores. In further aspects, the sensitivity threshold is set to a value higher than a preset percentage of the plurality of sensitivity scores.

At block 906, the computing device (or component thereof) can fine-tune parameters of the one or more layers based on application of the adapter to the one or more layers. For example, fine-tuning parameters can include adjusting various weights and other parameters of the machine learning model at the one or more layers where the adapter is applied.

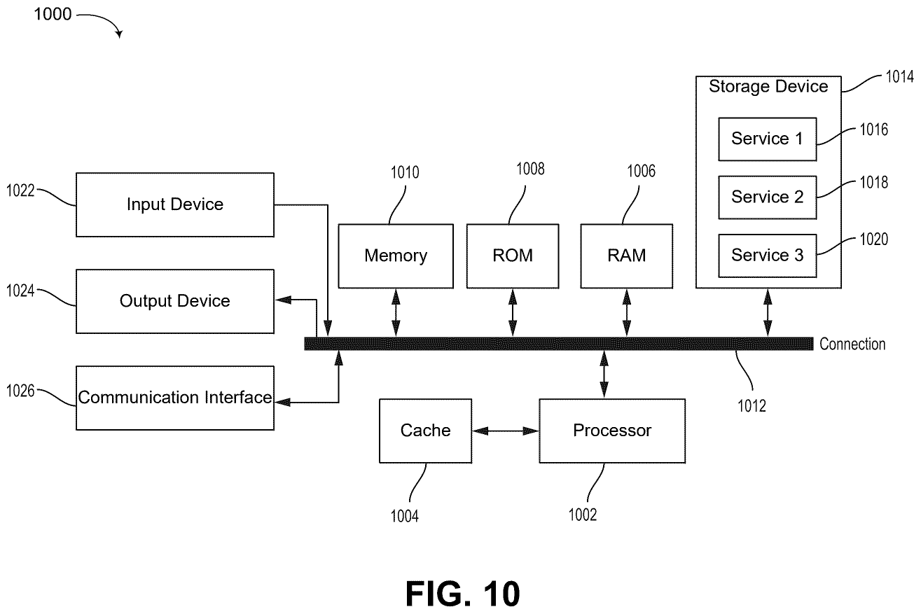

In some examples, as noted previously, the methods described herein (e.g., process 900 of FIG. 9 and/or other methods described herein) can be performed, in whole or in part, by a computing device or system. In one example, one or more of the methods can be performed by SOC 100 of FIG. 1, any one or more of the network 200, the network 204, and/or the network 206 of FIGS. 2A, 2B, and 2C, respectively, the architecture 1000 of FIG. 10, any combination thereof, and/or by another computing device or system. In another example, one or more of the processes (e.g., process 900 and/or other process described herein) can be performed, in whole or in part, by a computing device having the computing-device architecture 1000 shown in FIG. 10. For instance, a computing device with the computing-device architecture 1000 shown in FIG. 10 can include, or can be included in, or can be used with the components of the SOC 100 of FIG. 1, any one or more of the network 200, the network 204, and/or the network 206 of FIGS. 2A, 2B, and 2C, respectively, and can implement the operations of process and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 800, process 900, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 800 and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 10 illustrates an example computing-device architecture 1000 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 1000 may include, implement, or be included in any or all of the devices, modules, or systems described herein. Additionally or alternatively, computing-device architecture 1000 may be configured to perform process 800, process 900, and/or other process described herein.

The components of computing-device architecture 1000 are shown in electrical communication with each other using connection 1012, such as a bus. The example computing-device architecture 1000 includes a processing unit (CPU or processor) 1002 and computing device connection 1012 that couples various computing device components including computing device memory 1010, such as read only memory (ROM) 1008 and random-access memory (RAM) 1006, to processor 1002.

Computing-device architecture 1000 can include a cache of high-speed memory connected directly with, in close proximity to, or integrated as part of processor 1002. Computing-device architecture 1000 can copy data from memory 1010 and/or the storage device 1014 to cache 1004 for quick access by processor 1002. In this way, the cache can provide a performance boost that avoids processor 1002 delays while waiting for data. These and other modules can control or be configured to control processor 1002 to perform various actions. Other computing device memory 1010 may be available for use as well. Memory 1010 can include multiple different types of memory with different performance characteristics. Processor 1002 can include any general-purpose processor and a hardware or software service, such as service 1 1016, service 2 1018, and service 3 1020 stored in storage device 1014, configured to control processor 1002 as well as a special-purpose processor where software instructions are incorporated into the processor design. Processor 1002 may be a self-contained system, containing multiple cores or processors, a bus, memory controller, cache, etc. A multi-core processor may be symmetric or asymmetric.

To enable user interaction with the computing-device architecture 1000, input device 1022 can represent any number of input mechanisms, such as a microphone for speech, a touch-sensitive screen for gesture or graphical input, keyboard, mouse, motion input, speech and so forth. Output device 1024 can also be one or more of a number of output mechanisms known to those of skill in the art, such as a display, projector, television, speaker device, etc. In some instances, multimodal computing devices can enable a user to provide multiple types of input to communicate with computing-device architecture 1000. Communication interface 1026 can generally govern and manage the user input and computing device output. There is no restriction on operating on any particular hardware arrangement and therefore the basic features here may easily be substituted for improved hardware or firmware arrangements as they are developed.

Storage device 1014 is a non-volatile memory and can be a hard disk or other types of computer readable media which can store data that are accessible by a computer, such as magnetic cassettes, flash memory cards, solid state memory devices, digital versatile discs (DVDs), cartridges, random-access memories (RAMs) 1006, read only memory (ROM) 1008, and hybrids thereof. Storage device 1014 can include services 1016, 1018, and 1020 for controlling processor 1002. Other hardware or software modules are contemplated. Storage device 1014 can be connected to the computing device connection 1012. In one aspect, a hardware module that performs a particular function can include the software component stored in a computer-readable medium in connection with the necessary hardware components, such as processor 1002, connection 1012, output device 1024, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, magnetic or optical disks, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), flash memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, such as, a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1: An apparatus for fine-tuning machine learning models, the apparatus comprising: at least one memory; and at least one processor coupled to the at least one memory and configured to: determine a plurality of sensitivity scores based on a query to edit a first image, wherein each respective sensitivity score of the plurality of sensitivity scores is associated with a respective layer of a plurality of layers of a machine learning model; apply an adapter to one or more layers of the plurality of layers that have a respective sensitivity score greater than a sensitivity threshold; and fine-tune parameters of the one or more layers based on application of the adapter to the one or more layers.

Aspect 2: The apparatus of Aspect 1, wherein the at least one processor is configured to: generate the first image using the machine learning model including a first text caption as input; add noise to the first image to reconstruct the first image; and determine the plurality of sensitivity scores based on a gradient associated with a loss function representing differences between: a noise prediction used to reconstruct the first image from the first text caption; and a noise prediction used to generate a second image from an augmented version of the first text caption.

Aspect 3: The apparatus of Aspect 2, wherein the first text caption includes a description of the first image.

Aspect 4: The apparatus of any of Aspects 2 to 3, wherein the augmented version of the first text caption includes a second caption, the second caption including the first text caption augmented to include a description of features to be edited in the first image.

Aspect 5: The apparatus of any of Aspects 2 to 4, wherein the augmented version of the first text caption includes a request to edit the first image by changing one or more of an art style of the first image and a perspective view of a scene associated with the first image.

Aspect 6: The apparatus of any of Aspects 2 to 5, wherein the sensitivity threshold is variable based on the plurality of sensitivity scores.

Aspect 7: The apparatus of any of Aspects 2 to 6, wherein the sensitivity threshold is set to a value higher than a preset percentage of the plurality of sensitivity scores.

Aspect 8: The apparatus any of Aspects 2 to 7, wherein the adapter is a low-ranking adaptation (LoRA) adapter.

Aspect 9: The apparatus of Aspect 8, wherein the LoRA adapter is applied head-wise to the one or more layers that have the respective sensitivity score greater than the sensitivity threshold.

Aspect 10: A method for fine-tuning machine learning models, the method comprising: determining a plurality of sensitivity scores based on a query to edit a first image, wherein each respective sensitivity score of the plurality of sensitivity scores is associated with a respective layer of a plurality of layers of a machine learning model; applying an adapter to one or more layers of the plurality of layers that have a respective sensitivity score greater than a sensitivity threshold; and fine-tuning parameters of the one or more layers based on application of the adapter to the one or more layers.

Aspect 11: The method of Aspect 10, further comprising: generate the first image using the machine learning model including a first text caption as input; adding noise to the first image to reconstruct the first image; and determining the plurality of sensitivity scores based on a gradient associated with a loss function representing differences between: a noise prediction used to reconstruct the first image from the first text caption; and a noise prediction used to generate a second image from an augmented version of the first text caption.

Aspect 12: The method of Aspect 11, wherein the first text caption includes a description of the first image.

Aspect 13: The method of any of Aspects 11 to 12, wherein the augmented version of the first text caption includes a second caption, the second caption including the first text caption augmented to include a description of features to be edited in the first image.

Aspect 14: The method of any of Aspects 11 to 13, wherein the augmented version of the first text caption includes a request to edit the first image by changing one or more of an art style of the first image and a perspective view of a scene associated with the first image.

Aspect 15: The method of any of Aspects 10 to 14, wherein the sensitivity threshold is variable based on the plurality of sensitivity scores.

Aspect 16: The method of any of Aspects 10 to 15, wherein the sensitivity threshold is set to a value higher than a preset percentage of the plurality of sensitivity scores.

Aspect 17: The method of any of Aspects 10 to 16, wherein the adapter is a low-ranking adaptation (LoRA) adapter.

Aspect 18: The method of Aspect 17, wherein the LoRA adapter is applied head-wise to the one or more layers that have the respective sensitivity score greater than the sensitivity threshold.

Aspect 19: A non-transitory computer-readable medium is provided having stored thereon instructions that, when executed by at least one processor, cause the at least one processor to perform operations according to any of Aspects 10 to 18.

Aspect 20: A n apparatus for fine-tuning machine learning models is provided. The apparatus includes one or more means for performing operations according to any of Aspects 10 to 18.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but is to be accorded the full scope consistent with the language claims, wherein reference to an element in the singular is not intended to mean “one and only one” unless specifically so stated, but rather “one or more.”

What is claimed is:

1. An apparatus for fine-tuning machine learning models, the apparatus comprising:
at least one memory; and
at least one processor coupled to the at least one memory and configured to:
determine a plurality of sensitivity scores based on a query to edit a first image, wherein each respective sensitivity score of the plurality of sensitivity scores is associated with a respective layer of a plurality of layers of a machine learning model;
apply an adapter to one or more layers of the plurality of layers that have a respective sensitivity score greater than a sensitivity threshold; and
fine-tune parameters of the one or more layers based on application of the adapter to the one or more layers.

2. The apparatus of claim 1, wherein the at least one processor is configured to:
generate the first image using the machine learning model including a first text caption as input;
add noise to the first image to reconstruct the first image; and
determine the plurality of sensitivity scores based on a gradient associated with a loss function representing differences between:
a noise prediction used to reconstruct the first image from the first text caption; and
a noise prediction used to generate a second image from an augmented version of the first text caption.

3. The apparatus of claim 2, wherein the first text caption includes a description of the first image.

4. The apparatus of claim 2, wherein the augmented version of the first text caption includes a second caption, the second caption including the first text caption augmented to include a description of features to be edited in the first image.

5. The apparatus of claim 2, wherein the augmented version of the first text caption includes a request to edit the first image by changing one or more of an art style of the first image and a perspective view of a scene associated with the first image.

6. The apparatus of claim 1, wherein the sensitivity threshold is variable based on the plurality of sensitivity scores.

7. The apparatus of claim 1, wherein the sensitivity threshold is set to a value higher than a preset percentage of the plurality of sensitivity scores.

8. The apparatus of claim 1, wherein the adapter is a low-ranking adaptation (LoRA) adapter.

9. The apparatus of claim 8, wherein the LoRA adapter is applied head-wise to the one or more layers that have the respective sensitivity score greater than the sensitivity threshold.

10. A method for fine-tuning machine learning models, the method comprising:
determining a plurality of sensitivity scores based on a query to edit a first image, wherein each respective sensitivity score of the plurality of sensitivity scores is associated with a respective layer of a plurality of layers of a machine learning model;
applying an adapter to one or more layers of the plurality of layers that have a respective sensitivity score greater than a sensitivity threshold; and
fine-tuning parameters of the one or more layers based on application of the adapter to the one or more layers.

11. The method of claim 10, further comprising:
generating the first image using the machine learning model including a first text caption as input;
adding noise to the first image to reconstruct the first image; and
determining the plurality of sensitivity scores based on a gradient associated with a loss function representing differences between:
a noise prediction used to reconstruct the first image from the first text caption; and
a noise prediction used to generate a second image from an augmented version of the first text caption.

12. The method of claim 11, wherein the first text caption includes a description of the first image.

13. The method of claim 11, wherein the augmented version of the first text caption includes a second caption, the second caption including the first text caption augmented to include a description of features to be edited in the first image.

14. The method of claim 11, wherein the augmented version of the first text caption includes a request to edit the first image by changing one or more of an art style of the first image and a perspective view of a scene associated with the first image.

15. The method of claim 10, wherein the sensitivity threshold is variable based on the plurality of sensitivity scores.

16. The method of claim 10, wherein the sensitivity threshold is set to a value higher than a preset percentage of the plurality of sensitivity scores.

17. The method of claim 10, wherein the adapter is a low-ranking adaptation (LoRA) adapter.

18. The method of claim 17, wherein the LoRA adapter is applied head-wise to the one or more layers that have the respective sensitivity score greater than the sensitivity threshold.

19. A non-transitory computer readable medium storing code for fine-tuning machine learning models, the code comprising instructions executable by a processor to:
determine a plurality of sensitivity scores based on a query to edit a first image, wherein each respective sensitivity score of the plurality of sensitivity scores is associated with a respective layer of a plurality of layers of a machine learning model;
apply an adapter to one or more layers of the plurality of layers that have a respective sensitivity score greater than a sensitivity threshold; and
fine-tune parameters of the one or more layers based on application of the adapter to the one or more layers.

20. The non-transitory computer readable medium of claim 19, wherein the code further comprises instructions executable by the processor to:
generate the first image using the machine learning model including a first text caption as input;
add noise to the first image to reconstruct the first image; and
determine the plurality of sensitivity scores based on a gradient associated with a loss function representing differences between:
a noise prediction used to reconstruct the first image from the first text caption; and
a noise prediction used to generate a second image from an augmented version of the first text caption.
